(19) United States
(12) Patent Application Publication
(10) Pub. No.: US 2010/0301824 A1
(43) Pub. Date: Dec. 2, 2010

(54) STEP-UP DC/DC SWITCHING CONVERTER AND SEMICONDUCTOR INTEGRATED CIRCUIT DEVICE

(75) Inventors: Masahiko YAMAMOTO, Fussa (JP); Takao Okazaki, Hamura (JP)

Correspondence Address: MILES & STOCKBRIDGE PC, 1751 PINNACLE DRIVE, SUITE 500, MCLEAN, VA, 22102-3833, US

(73) Assignee: HITACHI, LTD.

(21) Appl. No.: 12/786,263

(22) Filed: May 24, 2010

(30) Foreign Application Priority Data
May 28, 2009 (JP) JP2009-128419

(51) Int. Cl. G05F 1/46

(52) U.S. Cl. 323/283

(57) ABSTRACT

A step-up DC/DC converter having a step-up circuit which can performs a stable control without depending on a logic threshold of a semiconductor switching device and a semiconductor integrated circuit device having the step-up DC/DC converter are provided. The step-up DC/DC converter includes: a control logic which generates a driving voltage to be supplied to a semiconductor switching device; a power supply circuit which steps-up a battery voltage to perform a level shift of the driving voltage output by the control logic; and an amplifier operated with using a voltage generated by the semiconductor switching device as a power supply. Since the level-shifted semiconductor switching device control signal is higher than a logic threshold voltage of the semiconductor switching device, the ON/OFF of the semiconductor switching device can be controlled.

### CROSS-REFERENCE TO RELATED APPLICATION

The present application claims priority from Japanese Patent Application No. 2009-128419 filed on May 28, 2009, the content of which is hereby incorporated by reference into this application.

### TECHNICAL FIELD OF THE INVENTION

The present invention relates to a step-up DC/DC switching converter. More particularly, it relates to a step-up DC/DC switching converter for stably operating a high-withstand-voltage and high-threshold load device such as a high-withstand-voltage amplifier which is driven by a battery power supply and outputs a voltage amplitude several tens of times as high as a voltage of the battery power supply (for example, several volts), and to a semiconductor integrated circuit device having the step-up DC/DC switching converter integrally formed on a semiconductor substrate.

### BACKGROUND OF THE INVENTION

As a conventional step-up DC/DC converter which steps-up an input DC voltage to convert it to an output DC voltage, a step-up DC/DC converter comprising: at least one switch; an inductance coil connected to the at least one switch; and a controller capable of supplying a control signal is disclosed, in which the at least one switch responds to the control signal in a first state in which it is in an on state for an on-time interval set based on the input DC voltage and a constant (for example, Japanese Patent Application Laid-Open Publication No. 2005-354892 (Patent Document 1)).

Further, as a conventional converter circuit and conversion method for converting an input signal with a first value to an output signal with a second value based on a switched operation mode, a technology is disclosed, in which an output feedback loop and an additional input forward control loop are provided with an aim that the additional input forward control loop has a function to correctly control a switching parameter not only for an output load but also for a wide input voltage range (for example, Japanese Patent Application Publication No. 2008-509643 (Patent Document 2)).

### SUMMARY OF THE INVENTION

In recent years, with an increase of battery-driven devices such as electronic devices, the requests for the low-voltage operation and the high-voltage output operation of the devices have been increasing.

FIG. 1 is a circuit configuration showing an example of a step-up DC/DC switching converter independently examined by the inventors of the present invention prior to the present invention.

An output voltage VDC is generated from an input voltage VBAT by a step-up DC/DC switching converter and then supplied to a load. The load is, for example, an amplifier.

The step-up DC/DC switching converter comprises a step-up circuit including a switching device and a switching device controller for controlling ON/OFF of the switching device. The step-up circuit is made up of, for example, an inductance coil L, a diode D and a transistor or another controllable semiconductor switching device 20.

Since the power supply of a driver 30 for driving the semiconductor switching device 20 is fed only from the input voltage VBAT, a high level voltage of a signal VGATE for driving the semiconductor switching device 20 is almost equal to the input voltage VBAT. More specifically, the driving voltage varies depending on the input voltage.

Generally, a logic threshold VTHsw of ON/OFF of the semiconductor switching device 20 has a value lower than the input voltage VBAT.

The driver 30 of the step-up DC/DC switching converter receives the input voltage VBAT and drives the semiconductor switching device 20. The semiconductor switching device 20 does not operate until reaching the logic threshold VTHsw, and the maximum voltage of the signal VGATE for driving the semiconductor switching device 20 is the input voltage at most. Therefore, the voltage dependence occurs in the maximum voltage of the signal VGATE, so that the drive capability becomes insufficient and the efficiency deterioration occurs in some cases. As a result, there is a possibility that the stable operation of an amplifier 50 serving as a load device cannot be maintained.

Further, there is also a possibility that the semiconductor switching device 20 cannot be turned on when the input voltage VBAT is lowered.

For increasing the driving force of the semiconductor switching device 20, the voltage of the driving signal during the on time must be increased as much as possible. To this end, the power supply of the driver 30 has to be fed from the output voltage VDC, but the problem may occur in the reliability when the withstand voltage of the driver 30 is lower than the output voltage VDC.

Further, when the logic threshold VTHsw of the semiconductor switching device 20 is higher than the input voltage VBAT, even if the power supply of the driver 30 is fed from the output voltage VDC, since the maximum voltage of the signal VGATE for driving the semiconductor switching device 20 does not reach the logic threshold VTHsw at the time of activation, the semiconductor switching device 20 remains in an off state as shown in FIG. 3.

Furthermore, when the logic threshold VTHsw of ON/OFF of the semiconductor switching device 20 is lower than the input voltage VBAT, the ON-time resistance of the semiconductor switching device tends to be increased in general. Therefore, the efficiency of the step-up DC/DC converter is decreased. Accordingly, when the step-up DC/DC converter supplies an electric power to the load device that requires high output, the voltage cannot be stepped up to a predetermined level, and there is a possibility that the load device cannot be stably operated.

In the technology of the Patent Document 1 described above, a step-up DC/DC converter which steps-up an input DC voltage to convert it to an output DC voltage comprises: at least one switch; an inductance coil connected to the at least one switch; and a controller capable of supplying a control signal, in which the at least one switch responds to the control signal in a first state in which it is in an on state for an on-time interval set based on the input DC voltage and a constant. Switches SW1 and SW2 are driven to an on state or an off state by a driver circuit 116 through paths 114 and 115, respectively. After the switch SW2 is turned off, a current is supplied to an output line 103 through a diode 110 or the switch SW1 109. A power supply input voltage VIN is supplied to a tON generator circuit 125 controlled in voltage through a path 124. The tON generator circuit 125 outputs a pulse having a duration time tON based on the input voltage VIN and a constant. The tON pulse is transmitted to a control logic circuit 121 through a path 123. During the tON pulse, the control logic circuit 121 delivers a signal to turn on the switch SW2 to a path 127 toward the driver circuit 116. In response to it, the driver 116 drives the switch SW2 to be in an on state.

However, this configuration does not have a function to step-up a switching device driving voltage supplied by the driver circuit 116 to the switches SW1 and SW2 through the paths 114 and 115, that is, a function of level shift of the driving voltage itself. What is achieved in this circuit configuration is just to generate the stepped-up voltage to be output to Vout by the switch-ON duration time tON based on the power supply input voltage VIN, and the drive capability of the signal output by the driver circuit 116 with respect to the switches SW1 and SW2, that is, whether or not the switches SW1 and SW2 themselves are normally ON/OFF operated is not considered at all. Therefore, the technology of the Patent Document 1 has the problem that the ON/OFF control of the switches SW1 and SW2 cannot be performed when the ON/OFF logic threshold voltage of the switches SW1 and SW2 is higher than the input DC voltage of the paths 114 and 115.

Also, in the technology of the Patent Document 2 described above, a converter circuit and conversion method for converting an input signal with a first value to an output signal with a second value based on a switched operation mode is disclosed, in which an output feedback loop and an additional input forward control loop are provided with an aim that the additional input forward control loop has a function to correctly control a switching parameter not only for an output load but also for a wide input voltage range. Although an output voltage Vout has a value higher than that of a power supply input voltage Vin and is substantially constant, the input voltage Vin and an output load can be changed. A DC voltage converter like this stores energy generated by a current flowing in an inductor L and a switching device 20 formed by a power transistor or other controllable semiconductor switching device by using the inductor L. The switching device 20 is used to switch off the relevant current path, and in this case, the energy stored in the inductor L is sent as current to an output through a diode D and charges a capacitor C connected in parallel to an output terminal. By continuously turning on and off the switching device 20, the energy stored in the inductor L is continuously transferred to the capacitor C through the diode D and charges the capacitor C. The diode D has a function to provide decoupling between the voltage in the capacitor C and the voltage in the switching device 20 so that the output voltage Vout can be higher than the input voltage Vin. The switching device 20 can be controlled by a PMW operation mode using a fixed frequency, and in order to maintain the output voltage Vout substantially constant, the duty cycle or the duration time of the switching phase is controlled. On the other hand, the switching device 20 can also be operated by a PFM operation mode, and in order to maintain the output voltage Vout substantially constant, the switching frequency can be changed. The switched operation mode is controlled by the driver circuit 10, and the driver circuit 10 comprises an oscillator and generates a control signal such as a square wave signal to supply it to a control terminal of the switching device 20. The output voltage Vout is controlled by a feedback loop 40, and the feedback loop 40 compares a value of the output voltage Vout with a reference voltage and then adjusts the switching frequency or the duty cycle based on the comparison result. An input control loop 60 monitors or inspects a value of the power supply input voltage Vin and compares it with an input reference voltage supplied by a reference voltage generator 52. When the input voltage Vin is excessively low, the duration time of a first phase of the converter circuit increases, so that more energy is stored in the inductor L, and as a result, more available energy is sent to an output side, that is, to the capacitor C, and an oscillator frequency is lowered. Alternatively, other switching parameter of the switching operation is controlled by the input control loop 60, and by this means, the duration time of the operation phase of the converter circuit can be adjusted. A sequencer 70 is provided so that the control loops 40 and 60 are operated without interference.

However, similar to the above-described Patent Document 1, this configuration does not have a function to step-up a switching device driving voltage supplied by the driver circuit 10 to the switching device 20, that is, a function of level shift of the driving voltage itself. What is achieved in this circuit configuration is just to generate the stepped-up voltage to be output to Vout by the switch-ON duration time based on the power supply input voltage Vin, and the drive capability of the signal output by the driver circuit 10 with respect to the switching device 20, that is, whether or not the switching device 20 itself is normally ON/OFF operated is not considered at all. Therefore, the technology of the Patent Document 2 has the problem that the ON/OFF control of the switching device 20 cannot be performed when the ON/OFF logic threshold voltage of the switching device 20 is higher than the input DC voltage from the driver circuit 10. As another problem, since the voltage level of the control signal for driving the switching device 20 is changed depending on the power supply input voltage Vin, the on resistance of the switching device 20 varies, and the power efficiency of the converter circuit varies under the condition of a wide input voltage range.

The typical ones of the inventions disclosed in the present application will be briefly described as follows. That is, a step-up DC/DC switching converter according to the present invention comprises: a semiconductor switching device; a control logic for generating a driving voltage supplied to the semiconductor switching device; a power supply circuit for stepping-up and outputting an input battery voltage; and a buffer having an output of the control logic as a signal input and having an output of the power supply circuit as a power supply input, performing a level shift of the driving voltage output by the control logic based on the power supply input and then supplying it to the semiconductor switching device, wherein the voltage generated in the semiconductor switching device is supplied to a load device operated with using the voltage as a power supply, thereby controlling the power supply of the load device.

Also, a semiconductor integrated circuit device according to the present invention is formed by integrally forming, on a common semiconductor substrate, a signal input terminal; a signal output terminal; a battery power supply input terminal; a direct current voltage input terminal; a semiconductor switching device control output terminal; a control logic which generates a driving voltage supplied to a semiconductor switching device; a power supply circuit which steps-up and outputs a battery voltage input through the battery power supply input terminal; a buffer having an output of the control logic as a signal input and having an output of the power supply circuit as a power supply input, performing a level shift of the driving voltage output by the control logic based on the power supply input and then supplying the driving voltage to the semiconductor switching device through the semiconductor switching device control output terminal; and an amplifier having an input connected to the signal input terminal and an output connected to the signal output terminal and operated with using both of the battery voltage input through the battery power supply input terminal and the voltage generated by the semiconductor switching device input through the direct current voltage input terminal as power supply.

According to the present invention, it is possible to provide a step-up DC/DC switching converter capable of supplying an electric power to a load device without depending on a logic threshold of a semiconductor switching device and maintaining a stable operation of the load device or a semiconductor integrated circuit device having the step-up DC/DC switching converter integrated therein.

### BRIEF DESCRIPTIONS OF THE DRAWINGS

FIG. 1 is a circuit configuration diagram of a conventional step-up DC/DC switching converter;

FIG. 2 is a circuit block configuration diagram showing an embodiment of a step-up DC/DC switching converter according to the present invention;

FIG. 3 is a waveform diagram for describing an operation in the case where a logic threshold of a semiconductor switching device of the conventional step-up DC/DC switching converter is higher than an input voltage;

FIG. 4 is a waveform diagram for describing an operation in the case where a logic threshold voltage of a semiconductor switching device of the step-up DC/DC converter of the present invention supplied from a power supply circuit which performs a level shift of the driving voltage output from the control logic by stepping-up a battery power supply voltage of the driver 30 for driving a switching device is higher than an input voltage;

FIG. 5 is a circuit block diagram showing an embodiment of a semiconductor integrated circuit device obtained by integrally forming a part of constituent elements of the step-up DC/DC switching converter according to the present invention and an amplifier corresponding to a load of the DC/DC converter on a common semiconductor substrate; and

FIG. 6 is a circuit block configuration diagram showing an example of a high-withstand-voltage amplifier in the case where a high-withstand-voltage amplifier is applied as an amplifier incorporated in the semiconductor integrated circuit device according to the present invention.

### DESCRIPTIONS OF THE PREFERRED EMBODIMENTS

For the achievement of the object described above, a step-up DC/DC switching converter according to the present invention comprises: a semiconductor switching device; a control logic which generates a driving voltage to be supplied to the semiconductor switching device; a power supply circuit for stepping-up and outputting an input battery voltage; and a buffer having an output of the control logic as a signal input and an output of the power supply circuit as a power supply input, performing a level shift of the driving voltage output by the control logic based on the power supply input and then supplying it to the semiconductor switching device. The step-up DC/DC switching converter supplies a voltage generated by the semiconductor switching device to a load device operated with using the voltage as a power supply, thereby controlling the power supply of the load device.

The control logic may include a circuit which controls a frequency of a signal for controlling the semiconductor switching device, may include a circuit which controls a duty cycle of a signal for controlling the semiconductor switching device, or may include both of them. The circuit which controls the duty cycle is preferably configured so as to control the duty cycle at the time of activating the load device.

The semiconductor switching device is preferably a field effect transistor (FET) having a drain-source breakdown voltage of about 200 V, that is, a so-called high-withstand-voltage FET. Also, the load device or the amplifier is preferably a so-called high-withstand-voltage amplifier or a piezoelectric device which amplifies a first voltage amplitude (low voltage amplitude) to a second voltage amplitude (high voltage amplitude) several tens of times as high as the first voltage amplitude.

Further, a semiconductor integrated circuit according to the present invention comprises: a control logic for generating a driving voltage to be supplied to a semiconductor switching device; a power supply circuit for performing a level shift of the driving voltage output by the control logic by stepping-up a battery voltage; and an amplifier operated with using the voltage generated by the switching device as a power supply.

More specifically, the semiconductor integrated circuit device according to the present invention has a configuration in which a signal input terminal; a signal output terminal; a battery power supply input terminal; a direct current voltage input terminal; a semiconductor switching device control output terminal; a control logic for generating a driving voltage to be supplied to a semiconductor switching device; a power supply circuit for stepping-up a battery voltage input through the battery power supply input terminal and outputting the stepped-up voltage; a buffer having an output of the control logic as a signal input and an output of the power supply circuit as a power supply input, performing a level shift of the driving voltage output by the control logic based on the power supply input and then supplying the driving voltage to the semiconductor switching device through the semiconductor switching device control output terminal; and an amplifier having an input connected to the signal input terminal and an output connected to the signal output terminal and operated with using both of the battery voltage input through the battery power supply input terminal and the voltage generated by the semiconductor switching device input through the direct current voltage input terminal as power supply are integrally formed on a common semiconductor substrate.

In this case, the control logic, the semiconductor switching device, the load device or the amplifier are the same as those of the above-described step-up DC/DC switching converter according to the present invention.

Hereinafter, embodiments of the present invention will be described in detail with reference to the accompanying drawings.

### First Embodiment

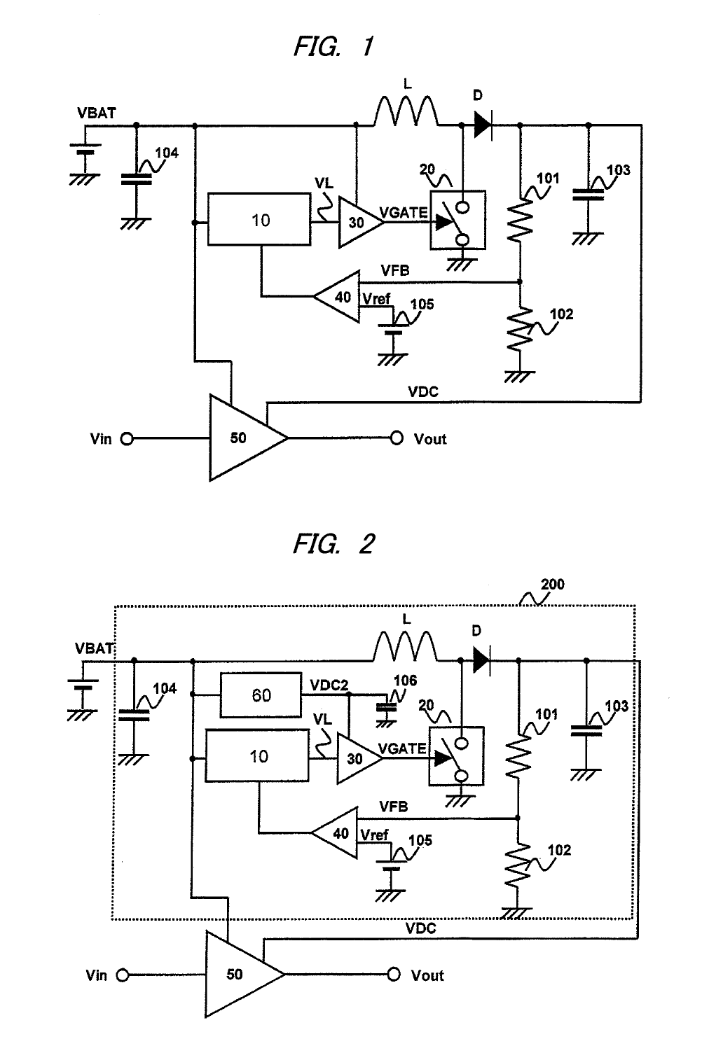

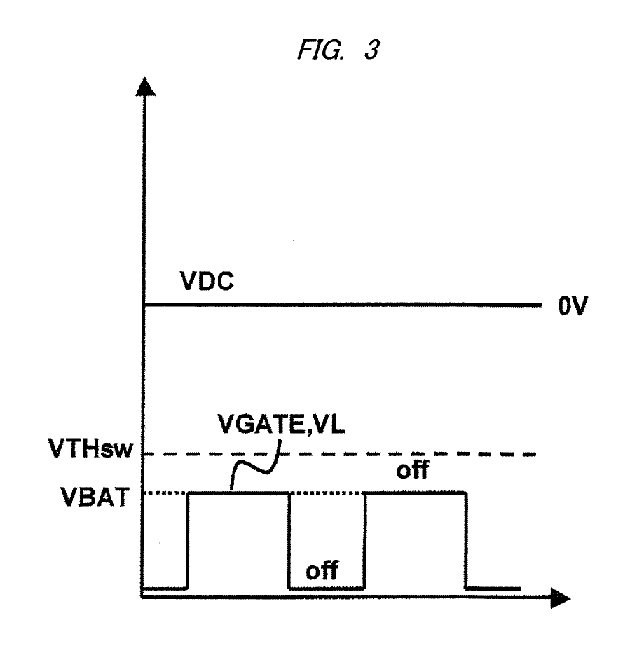

FIG. 2 is a circuit block diagram showing an embodiment of a step-up DC/DC switching converter according to the present invention. A step-up control unit 200 in this embodiment supplies an electric power to a load device 50 with using an input voltage VBAT as a power supply source.

The step-up DC/DC switching converter according to the present embodiment includes: an inductor coil L, a semiconductor switching device 20 which switches an output of the inductor coil L; a diode D; a switching control logic circuit 10 which controls the switching; a buffer 30 which drives the semiconductor switching device 20; a level shift power supply circuit 60 which supplies power to the buffer 30; resistors 101 and 102 for detecting a power supply output voltage VDC of the step-up control unit 200; a reference voltage generator circuit 105 for generating a reference voltage Vref for performing a feedback control of the control logic circuit 10; a feedback control circuit 40 for generating a control signal to the switching control logic circuit 10; and the load device 50.

The switching control logic circuit 10 controls ON/OFF of the semiconductor switching device 20. A transistor is mainly used as the semiconductor switching device 20.

A feedback voltage VFB obtained by dividing the power supply output voltage VDC by the resistors 101 and 102 and the reference voltage Vref are input to the feedback control circuit 40. By this means, after determining a difference voltage between the feedback voltage VFB and the reference voltage Vref, a signal is transmitted to the switching control logic circuit 10, and the power supply output voltage VDC is controlled at an approximately constant voltage.

In the step-up control unit 200 shown in FIG. 2, the output of the buffer 30 whose power is supplied from the level shift power supply circuit 60, that is, the high level of the semiconductor switching device control signal VGATE is VDC2.

The level shift power supply circuit 60 can step-up the input voltage VBAT to a predetermined voltage so as to be higher than the logic threshold voltage VTHsw of the semiconductor switching device 20. The level shift power supply circuit 60 is controlled to an approximately constant voltage with respect to the input voltage VBAT. The level shift power supply circuit 60 can be fully or partly integrated in the same integrated circuit.

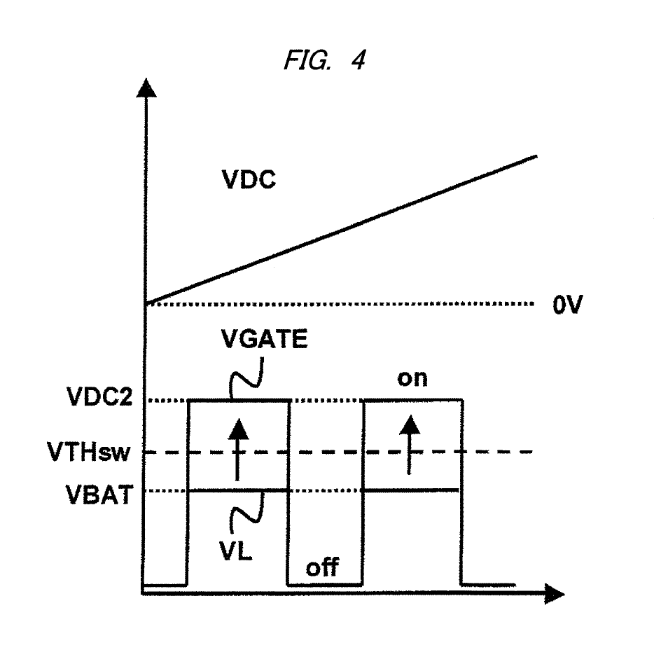

FIG. 4 is a waveform diagram showing the characteristics of the semiconductor switching device control signal VGATE and the power supply output voltage VDC in the buffer 30 shown in FIG. 2.

As is apparent from FIG. 4, the output signal VL of the switching control logic circuit 10 is input to the buffer 30, and the high level of the semiconductor switching device control signal VGATE is level-shifted to the power supply output voltage VDC2 which is higher than the logic threshold VTHsw of the semiconductor switching device 20. Therefore, the semiconductor switching device 20 can be turned ON/OFF. As a result, the power supply output voltage VDC can be stepped-up to a predetermined voltage.

Further, since the output voltage VDC2 of the level shift power supply circuit 60 is controlled to an approximately constant voltage with respect to the input voltage VBAT, the high level of the semiconductor switching device control signal VGATE outputs an approximately constant voltage. More specifically, even when the input voltage VBAT is changed, the semiconductor switching device can be driven under the approximately same condition. Accordingly, the stable operation of the amplifier 50 serving as a load device can be maintained.

According to the present embodiment, it is possible to provide a step-up DC/DC converter capable of supplying an electric power to a load device without depending on a logic threshold of a semiconductor switching device and maintaining a stable operation of the load device. In addition, since the voltage level of the driving signal for driving the semiconductor switching device 20 is not changed by the power supply input voltage VBAT, the variation in the on resistance of the semiconductor switching device 20 can be suppressed, and the variation in the power efficiency of the DC/DC converter can be suppressed in a wide input voltage range.

Note that the switching control logic circuit 10 shown in FIG. 2 outputs a control signal (driving signal) to the buffer 30 to control the ON/OFF of the semiconductor switching device 20, and a pulse width modulation (PWM) circuit and a pulse frequency modulation (PFM) circuit can be applied as an example thereof.

The pulse width modulation circuit has a function to generate a driving signal by changing a duty cycle of a pulse waveform. When the duty cycle of the switching device is increased (long on-time), the output voltage is increased, and when the duty cycle is decreased (short on-time), the output voltage is lowered. Therefore, the constant output voltage can be controlled by controlling the duty cycle of the pulse waveform.

The pulse frequency modulation circuit has a function to generate a driving signal by changing a frequency of a pulse waveform. In order to maintain the constant output voltage, when the load current is low, the pulse frequency is lowered because the number of times of ON/OFF of the pulse can be small, and when the load current is high, the pulse frequency is increased because the number of times of ON/OFF of the pulse has to be increased.

Further, it is also possible to incorporate a soft-start circuit which regulates the inrush current at the start of the stepping-up. As an example of the soft-start circuit, a circuit which controls the duty cycle at the start of the stepping-up may be used. This circuit controls the duty cycle so as to increase from a small duty cycle (for example, about 10%) in a step-by-step manner at certain intervals at the start of the stepping-up.

Further, an amplifier having a fixed gain or an amplifier having a switchable gain may be used as the load device 50, but it is needless to say that the load device 50 of the present invention is not limited to these and any load devices which need to stabilize the power supply are applicable as the load device 50. For example, a high-withstand-voltage driver can be applied as the load device.

### Second Embodiment

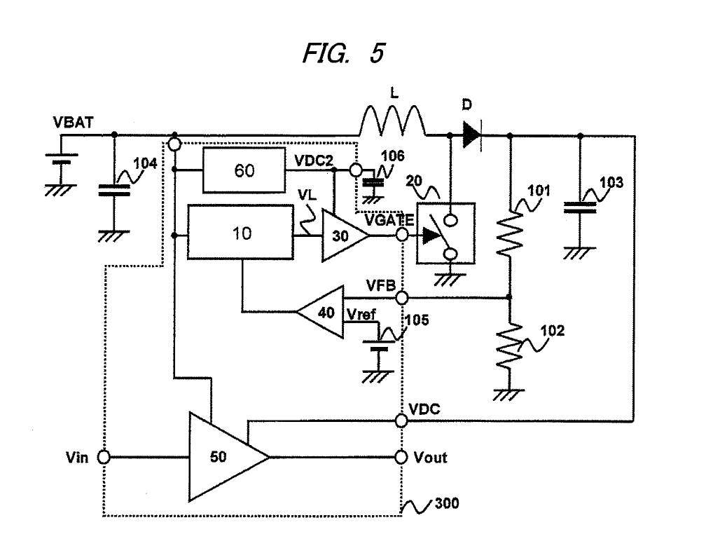

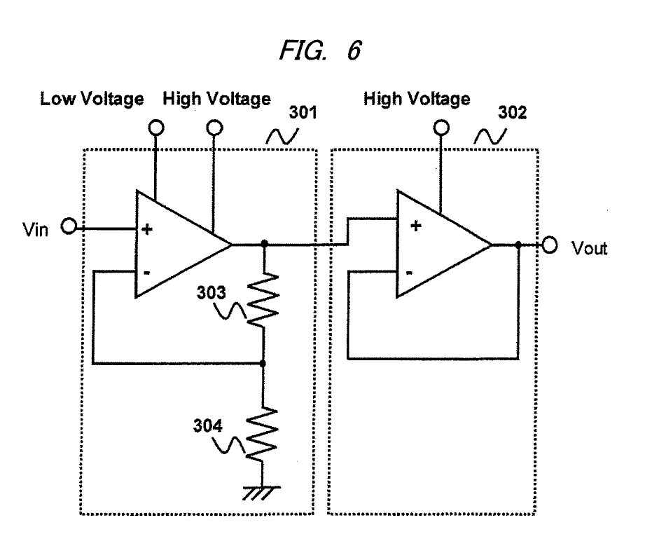

FIG. 5 is a circuit block diagram showing an embodiment of a semiconductor integrated circuit device obtained by integrally forming a part of constituent elements of the step-up DC/DC switching converter according to the present invention and an amplifier corresponding to a load of the DC/DC converter on a common semiconductor substrate. A step-up controller 200 of this embodiment supplies an electric power to the amplifier 50 with using the input voltage VBAT as a power supply source.

A semiconductor integrated circuit device 300 of the present embodiment is made up by providing at least a switching control logic circuit 10 for controlling the switching of the semiconductor switching device 20, a buffer 30 for driving the semiconductor switching device 20, a level shift power supply circuit 60 for supplying power to the buffer 30 and the amplifier 50 on a common semiconductor substrate. The reference voltage generator circuit 105 which generates a reference voltage Vref for performing the feedback control to the control logic circuit 10 and the feedback control circuit 40 which generates a control signal to the switching control logic circuit 10 may be further incorporated and integrated in the semiconductor integrated circuit device 300, but the present invention is not limited to such an embodiment. On the other hand, it is preferable that the inductor coil L, the semiconductor switching device 20 for switching an output of the inductor coil L, the diode D and resistors 101 and 102 for detecting the direct current power supply output voltage VDC are provided as components externally attached to the semiconductor integrated circuit device 300.

The semiconductor integrated circuit 300 includes at least a signal input terminal Vin, a signal output terminal Vout, a battery power supply input terminal VBAT, a direct current power supply input terminal VDC and a semiconductor switching device control output terminal VGATE. The signal input terminal Vin is connected to an input of the amplifier 50, and an input signal is input to the amplifier 50 through the signal input terminal Vin. The signal output terminal Vout is connected to an output of the amplifier 50, and a signal amplified and output by the amplifier 50 is output to the outside of the semiconductor integrated circuit device 300 through the signal output terminal Vout. The battery power supply input terminal VBAT is connected to the switching control logic circuit 10, the level shift power supply circuit 60 and the amplifier 50, and the voltage of the externally attached battery is supplied to the switching control logic circuit 10, the level shift power supply circuit 60 and the amplifier 50 through the power supply input terminal VBAT. The direct current power supply input terminal VDC is connected to the amplifier 50, the stabilized direct current generated by the operation of the semiconductor switching device 20 is supplied to the amplifier 50 through the direct current power supply input terminal VDC. The semiconductor switching device control output terminal VGATE is connected to an output of the buffer 30, and the driving voltage which has been level-shifted by the buffer 30 and the level shift power supply circuit 60 is supplied to the semiconductor switching device 20 through the semiconductor switching device control output terminal VGATE. When the reference voltage generator circuit 105 which generates the reference voltage Vref for performing the feedback control to the control logic circuit 10 and the feedback control circuit 40 for generating the control signal to the switching control logic circuit 10 are provided in the semiconductor integrated circuit device 300 or outside the semiconductor integrated circuit device 300, the semiconductor integrated circuit device 300 further includes the feedback voltage input terminal VFB. In particular, when the reference voltage generator circuit 105 and the feedback control circuit 40 are incorporated in the semiconductor integrated circuit device 300, the feedback voltage input terminal VFB is connected to an input of the feedback control circuit 40, and the feedback voltage signal generated by the operation of the switching device 20 and the resistors 101 and 102 is input to the feedback control circuit 40 through the feedback voltage input terminal VFB. Also, when a ground capacitor 106 is provided outside the semiconductor integrated circuit device 300, the semiconductor integrated circuit device 300 further includes a terminal for connecting the capacitor 106 to the level shift power supply circuit 60 and the buffer 30.

The switching control logic circuit 10 controls ON/OFF of the semiconductor switching device 20. A transistor is mainly used as the semiconductor switching device 20.

The feedback voltage VFB obtained by dividing the power supply output voltage VDC by the resistors 101 and 102 and the reference voltage Vref are input to the feedback control circuit 40. By this means, after determining a difference voltage between the feedback voltage VFB and the reference voltage Vref, a signal is transmitted to the switching control logic circuit 10, and the power supply output voltage VDC is controlled to an approximately constant voltage.

In the semiconductor integrated circuit device 300 shown in FIG. 5, the output of the buffer 30 whose power is supplied from the level shift power supply circuit 60, that is, the high level of the semiconductor switching device control signal VGATE is VDC2.

The level shift power supply circuit 60 can step-up the input voltage VBAT to a predetermined voltage so as to be higher than the logic threshold voltage VTHsw of the semiconductor switching device 20. The level shift power supply circuit 60 is controlled to an approximately constant voltage with respect to the input voltage VBAT. In the example shown in FIG. 5, the level shift power supply circuit 60 is fully integrated in the semiconductor integrated circuit device 300, but the present invention is not limited to the embodiment. For example, the power supply circuit 50 may be partly integrated in the semiconductor integrated circuit device 300 and partly provided outside the semiconductor integrated circuit device 300 as an external component.

A waveform diagram showing the characteristics of the semiconductor switching device control signal VGATE and the power supply output voltage VDC in the buffer 30 shown in FIG. 5 is the same as the waveform diagram (FIG. 4) in the buffer 30 shown in FIG. 2 of the first embodiment.

More specifically, the output signal VL of the switching control logic circuit 10 is input to the buffer 30, and the high level of the semiconductor switching device control signal VGATE is level-shifted to the power supply output voltage VDC2 which is higher than the logic threshold VTHsw of the semiconductor switching device 20. Therefore, the semiconductor switching device 20 can be turned ON/OFF. As a result, the power supply output voltage VDC can be stepped-up to a predetermined voltage.

Further, since the output voltage VDC2 of the level shift power supply circuit 60 is controlled to an approximately constant voltage with respect to the input voltage VBAT, the high level of the semiconductor switching device control signal VGATE outputs an approximately constant voltage. More specifically, even when the input voltage VBAT is changed, the semiconductor switching device 20 can be driven under the approximately same condition. Accordingly, the stable operation of the amplifier 50 serving as a load device can be maintained.

FIG. 6 is a circuit block configuration diagram showing an example of a high-withstand-voltage amplifier in the case where a high-withstand-voltage amplifier is applied as the amplifier 50 incorporated in the semiconductor integrated circuit device 300. The high-withstand-voltage amplifier includes a non-inverting amplifier 301 and a voltage follower 302. The power supply of the high-withstand-voltage amplifier has a low voltage source and a high voltage source, and the voltage of the low voltage source can be, for example, 3 to 5 V and the voltage of the high voltage source can be, for example, 150 V. The high-withstand-voltage amplifier is a device which amplifies the low voltage amplitude (for example, Vin=1.8 Vpp) to the high voltage amplitude (for example, 100 Vpp).

According to the present embodiment, it is possible to provide a semiconductor integrated circuit device in which a part of constituent elements of a step-up DC/DC converter capable of supplying an electric power to an amplifier serving as a load device without depending on a logic threshold of a semiconductor switching device and maintaining a stable operation of the load device is integrally formed on a single semiconductor substrate together with the amplifier. In addition, since the voltage level of the driving signal for driving the semiconductor switching device 20 is not changed by the power supply input voltage VBAT, the variation in the on resistance of the semiconductor switching device 20 can be suppressed, and it is thus possible to provide the semiconductor integrated circuit device in which the variation in the power efficiency of the DC/DC converter circuit can be suppressed in a wide input voltage range.

Note that the switching control logic circuit 10 shown in FIG. 5 outputs a control signal (driving signal) to the buffer 30 to control the ON/OFF of the semiconductor switching device 20, and a pulse width modulation (PWM) circuit and a pulse frequency modulation (PFM) circuit can be applied as an example thereof.

The pulse width modulation circuit has a function to generate a driving signal by changing a duty cycle of a pulse waveform. When the duty cycle of the switching device is increased (long on-time), the output voltage is increased, and when the duty cycle is decreased (short on-time), the output voltage is lowered. Therefore, the constant output voltage can be controlled by controlling the duty cycle of the pulse waveform.

The pulse frequency modulation circuit has a function to generate a driving signal by changing a frequency of a pulse waveform. In order to maintain the constant output voltage, when the load current is low, the pulse frequency is lowered because the number of times of ON/OFF of the pulse can be small, and when the load current is high, the pulse frequency is increased because the number of times of ON/OFF of the pulse has to be increased.

Further, it is also possible to incorporate a soft-start circuit which regulates the inrush current at the start of the stepping-up. As an example of the soft-start circuit, a circuit which controls the duty cycle at the start of the stepping-up may be used. This circuit controls the duty cycle so as to increase from a small duty cycle (for example, about 10%) in a step-by-step manner at certain intervals at the start of the stepping-up.

Further, an amplifier having a fixed gain or an amplifier having a switchable gain may be used as the amplifier 50, but it is needless to say that the amplifier 50 of the present invention is not limited to these and any load devices which need to stabilize the power supply are applicable as the amplifier 50.

What is claimed is:

1. A step-up DC/DC switching converter comprising:
a semiconductor switching device;
a control logic for generating a driving voltage supplied to the semiconductor switching device;
a power supply circuit for stepping-up and outputting an input battery voltage; and
a buffer having an output of the control logic as a signal input and having an output of the power supply circuit as a power supply input, performing a level shift of the driving voltage output by the control logic based on the power supply input and then supplying it to the semiconductor switching device,
wherein the voltage generated in the semiconductor switching device is supplied to a load device operated with using the voltage as a power supply, thereby controlling the power supply of the load device.

2. The step-up DC/DC switching converter according to claim 1,
wherein the control logic includes a circuit which controls a frequency of a signal for controlling the semiconductor switching device.

3. The step-up DC/DC switching converter according to claim 1,
wherein the control logic includes a circuit which controls a duty cycle of a signal for controlling the semiconductor switching device.

4. The step-up DC/DC switching converter according to claim 3,
wherein the control logic further includes a circuit which controls a frequency of a signal for controlling the semiconductor switching device.

5. The step-up DC/DC switching converter according to claim 3,
wherein the circuit which controls the duty cycle controls the duty cycle when the load device is activated.

6. The step-up DC/DC switching converter according to claim 5,
wherein the control logic further includes a circuit which controls a frequency of a signal for controlling the semiconductor switching device.

7. The step-up DC/DC switching converter according to claim 1,
wherein the semiconductor switching device is a field effect transistor having a drain-source breakdown voltage of about 200 V.

8. The step-up DC/DC switching converter according to claim 1,
wherein the load device is an amplifier which amplifies a first voltage amplitude to a second voltage amplitude which is a voltage amplitude several tens of times as high as the first voltage amplitude.

9. A semiconductor integrated circuit device, wherein
a signal input terminal;
a signal output terminal;
a battery power supply input terminal;
a direct current voltage input terminal;
a semiconductor switching device control output terminal;
a control logic which generates a driving voltage supplied to a semiconductor switching device;
a power supply circuit which steps-up and outputs a battery voltage input through the battery power supply input terminal;
a buffer having an output of the control logic as a signal input and having an output of the power supply circuit as a power supply input, performing a level shift of the driving voltage output by the control logic based on the power supply input and then supplying the driving voltage to the semiconductor switching device through the semiconductor switching device control output terminal; and
an amplifier having an input connected to the signal input terminal and an output connected to the signal output terminal and operated with using both of the battery voltage input through the battery power supply input terminal and the voltage generated by the semiconductor switching device input through the direct current voltage input terminal as power supply are integrally formed on a common semiconductor substrate.

10. The semiconductor integrated circuit device according to claim 9,
wherein the control logic includes a circuit which controls a frequency of a signal for controlling the semiconductor switching device.

11. The semiconductor integrated circuit device according to claim 9,
wherein the control logic includes a circuit which controls a duty cycle of a signal for controlling the semiconductor switching device.

12. The semiconductor integrated circuit device according to claim 11,
wherein the control logic further includes a circuit which controls a frequency of a signal for controlling the semiconductor switching device.

13. The semiconductor integrated circuit device according to claim 11,
wherein the circuit which controls the duty cycle controls the duty cycle when the load device is activated.

14. The semiconductor integrated circuit device according to claim 13,
wherein the control logic further includes a circuit which controls a frequency of a signal for controlling the semiconductor switching device.

15. The semiconductor integrated circuit device according to claim 9,
wherein the semiconductor switching device is a field effect transistor having a drain-source breakdown voltage of about 200 V.

16. The semiconductor integrated circuit device according to claim 9,
wherein the amplifier is an amplifier which amplifies a first voltage amplitude to a second voltage amplitude which is a voltage amplitude several tens of times as high as the first voltage amplitude.
